(19) United States
(12) Patent Application Publication
(10) Pub. No.: US 2025/0187274 A1
(43) Pub. Date: Jun. 12, 2025

(54) INSERT STAKING DEVICE AND METHOD

(71) Applicant: Alex Spurgeon, Grove City, OH (US)

(72) Inventor: Alex Spurgeon, Grove City, OH (US)

(21) Appl. No.: 18/537,686

(22) Filed: Dec. 12, 2023

(51) Int. Cl. B29C 65/38; B29C 65/00; H05B 3/22

(52) U.S. Cl. CPC B29C 65/38; B29C 66/74281; H05B 3/22

(57) ABSTRACT

A novel device and method enabling insert staking of brass inserts into plastic.

### CROSS REFERENCE TO RELATED APPLICATIONS

This application claims the benefit of U.S. Provisional Application No. 63/387,164, filed on Dec. 13, 2022.

### STATEMENT REGARDING FEDERALLY SPONSORED RESEARCH AND DEVELOPMENT

No federally sponsored research and development.

### BACKGROUND OF THE INVENTION

The present disclosure relates to a novel device and method enabling impulse insert staking of brass inserts into plastic.

The purpose of insert staking is to embed a brass, or other metal, insert into plastic. A hole in the plastic item is positioned to facilitate joining the plastic item with another item, via a hole through which a screw, bolt, or similar entity is used to secure the items. The insert is provided with threads or a shaft to accommodate securing the items.

### PRIOR ART

Staking, in general, is used in the plastics industry to join two or more parts, where at least one of the parts is plastic. The process is to deform the plastic material using heat and force over a specific time. A bond is made by partially de-forming the plastic part in order to be affixed mechanically to another part.

A subset of heat stacking is insert staking, used in the plastic industry to assemble brass inserts into plastic parts. A hole in the plastic has a diameter slightly smaller than the insert to be embedded. The insert itself is provided with knurls, grooves, undercuts, and other physical attributes to dig into softened plastic. The heated insert is then pressed, or thrusted, into the hole in the plastic, and then released. The plastic is momentarily softened and partially melted by the heat and pressing. The softened and partially melted plastic then flows around the grooves, knurls, and undercuts in the insert.

When the heated plastic cools, the insert is secured in place. Typically, the brass insert, once embedded into the plastic, would receive a screw or bolt which in turn would be used to assemble the plastic part and other parts.

Insert staking is typically done by one of three methods, each of which has a problem:

1. Hot Probe Insert Staking-A metal probe heated to 300-400 degrees Fahrenheit makes contact with the brass insert to heat it and is then pressed into the plastic part. The problem with this is that the probe is always hot and can burn operators.

2. Inductive Insertion-A brass insert is heated in an induction coil and then pressed into the plastic part. This is the best option right now for inserting applications because it offers a lot of control over the process. However, this can be expensive and requires significant of machine actuation to work.

3. Ultrasonic Inserting—An ultrasonic horn transmits high-frequency sound vibrations to a brass insert. The vibrations create heat in the insert, which is then pressed into a plastic part. The plastic part is heated as a result, and softened, thereby allowing the insert to be embedded. Both the frequency and intensity of the vibrations make this hazardous for operators.

Impulse methodology is an alternative method that uses electrical resistance at a tip to heat the insert before and as it is inserted into the hole in the plastic. The tip essentially creates an electrical short circuit. By passing a low voltage alternating current through the tip, heat is created at the tip. Heat is then conducted to the insert, and in turn, conducted to the plastic. The plastic is softened, and the insert is pressed into place.

Because of the problems of hot probe insert staking, inductive insertion, and ultrasonic insertion, and the advantages of impulse methodology, a need exists for viable impulse insertion.

### SUMMARY OF THE INVENTION

The present disclosure comprises a novel device that enables efficient impulse insertion of brass, or other metal, inserts into plastic. Impulse Inserting offers more control over the process than the other applications at a lower cost and low risk of burns or other harm to the operator. The small form factor and no noise make it ideal for many applications.

A brass insert is held in place by a specially designed collar that is spring-loaded to hold the insert but then to release it once it is in the plastic. Once the brass insert makes contact with the part the resistive tip is heated and that heat conducts into the brass insert. The heated brass insert is then pressed into the plastic with a spring-loaded thruster. After reaching depth the impulse tip is cooled along with the brass insert. This sets the insert and cools the plastic to ensure that it does not come back out when the tip retracts.

### DETAILED DESCRIPTION OF THE INVENTION

In the following detailed description, reference is made to the accompanying drawings, which form a part hereof, and in which are shown various specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the present disclosure. The following detailed description, therefore, is not to be taken in a limiting sense. The scope of the present disclosure is defined only by the appended claims, along with the full scope of equivalents to which such claims are entitled.

The following reference numbers are used in the figures and accompanying descriptions:
100 Insert staker
102 Bracket
104 Sleeve bearing
106 Screw
108 Potting
110 Tip
111 Alignment protrusion
112 Washer
113 Slot
114 Spring
116 Insert collar
117 Notch
118 Leaf spring
120 Air tube
122 Operation end
124 Hole
126 Hole
130 Insert
132 Top
134 Bottom
202 Deep lead
302 Plastic part
304 Hole
306 Grip surface
308 Anchor end
310 Insert end
312 Distance
400 Insert stacker
402 Air tube
404 Lead
405 Hole
406 Carriage
407 Bearing
408 Potting
410 Rail
412 Base
413 Stop
414 Mount
415 Hole
416 Set screw
418 Screw
420 Screw
422 Screw
900 Method
902 Initial condition
904 Engaging
906 Acquiring
908 Placing
910 Heating
912 Pressing
914 Releasing
916 Returning
920 Method
922 Initial condition
924 Engaging
925 Contacting
926 Heating
928 Pressing
930 Returning

### BRIEF DESCRIPTION OF DRAWINGS

For a fuller understanding of the nature and advantages of the present method and process, reference should be had to the following detailed description taken in connection with the accompanying drawings, in which:

FIG. 1 shows a perspective view of insert staker 100 as assembled.

FIG. 2 is an exploded perspective view of a distal end of insert staker 100, further revealing the underlying structure and other elements.

FIG. 3 is a close-up, perspective view of one leaf spring 118.

FIG. 4A is a perspective view of potting 108, with tip 110, and air tube 120.

FIG. 4B is an exploded perspective view of potting 108, showing more of tip 110, placement of deep leads 202, and placement of air tube 120.

FIG. 5 is a close-up view of insert 130.

FIGS. 6A and 6B are is cross-section views of operation end 122 of insert staker 100.

FIG. 7 shows alternative embodiment insert staker 400.

FIG. 8 is an exploded perspective view of alternative embodiment insert staker 400, further revealing the underlying structure and other elements.

FIGS. 9A and 9B show methods 900 and 920, respectively.

FIGS. 10A, 10B, and 10C show insert staker 100 operating in sequence to place and then release insert 130 to hole 304, in plastic part 302.

FIGS. 11A, 11B, 11C, and 11D show insert staker 400 operating in sequence to place and then release insert 130 to hole 304, in plastic part 302.

The drawings are described in greater detail below.

### DETAILED DESCRIPTION OF THE DRAWINGS

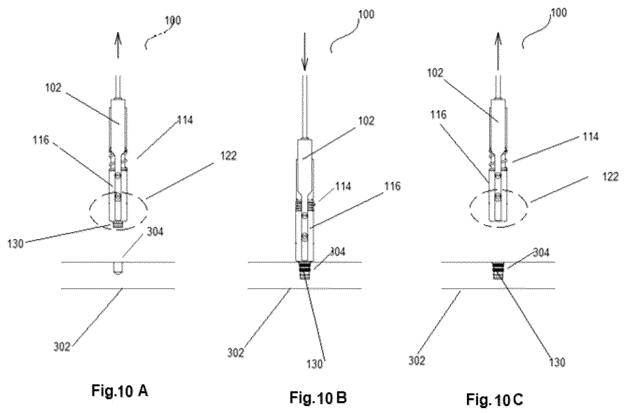

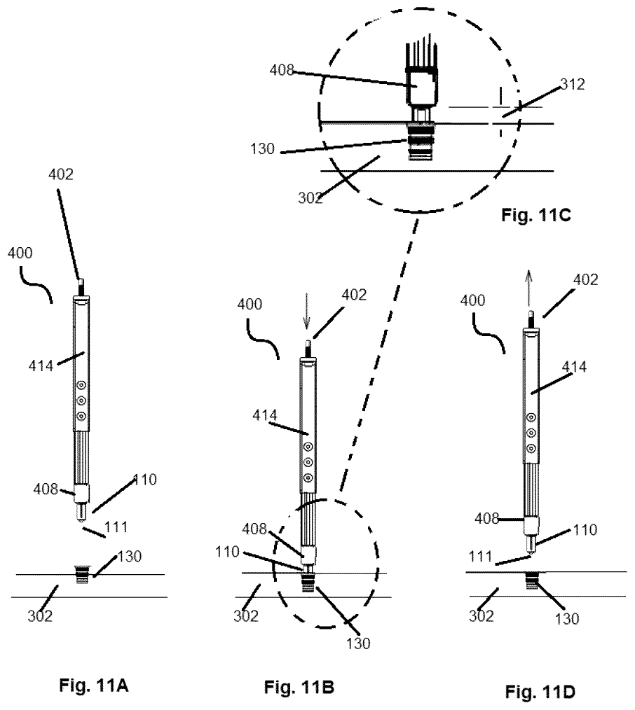

For an overview of insert staking, consider FIGS. 10A, 10B, and 10C, which show a plastic part 302 which includes a hole 304 into which an insert 130 is to be embedded. Consider also FIGS. 11A, 11B, 11C, and 11D, for an alternative view of insert staking. Fuller explanation is provided below.

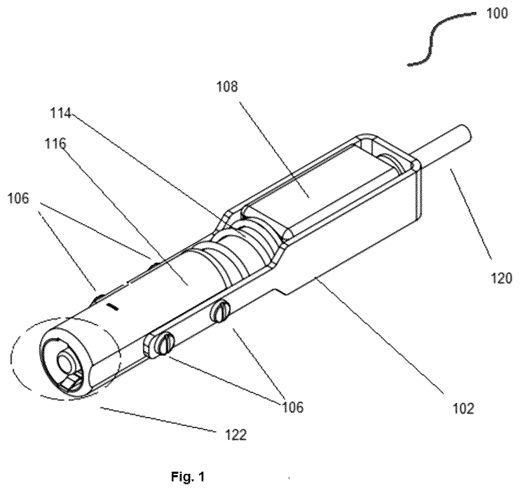

FIG. 1 shows a perspective view of an insert staker 100. U-shaped bracket 102 and insert collar 116 are joined via screws 106. Potting 108 is fixed to air tub 120 and moves with it. The combination of bracket 102 and insert collar 116 slides along air tube 120, with mechanical resistance provided by spring 114 against potting 108. Operation end 122 is where insert 130 (not shown in FIG. 1) would be held before insertion

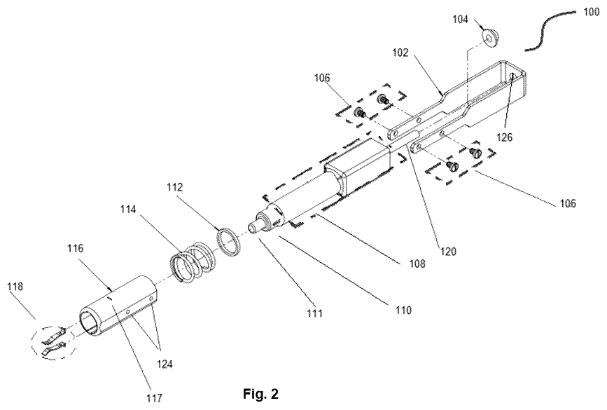

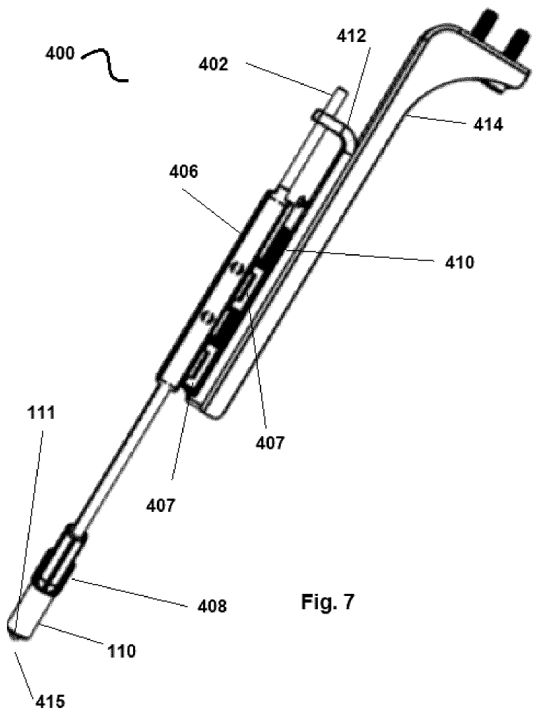

FIG. 2 is an exploded perspective view of a distal end of insert staker 100, further revealing the underlying structure and other elements. Air tube 120 moves linearly, generally up and down with respect to gravity, through sleeve bearing 104. This linear motion pushes the attached potting 108 linearly, which in turn pushes tip 110, collar 116, and releasably attached insert 130 (not shown in FIG. 2). As discussed below concerning FIG. 7, mechanical resistance at the operational end 122 pushes against the downward direction of the insert 130, insert collar 116, and bracket 102, further restrained by spring 114 against washer 112 and potting 108. Further, again as discussed below, leaf spring 118 will release insert 130 (not shown) in reaction to the downward movement and resistance against plastic part 302 (not shown). As shown, screws 106 are placed in holes 124 join bracket 102, and insert collar 116. The U-shaped attribute of bracket 102 facilitates movement of the bracket 102 and insert collar 116 combination along air tube 120.

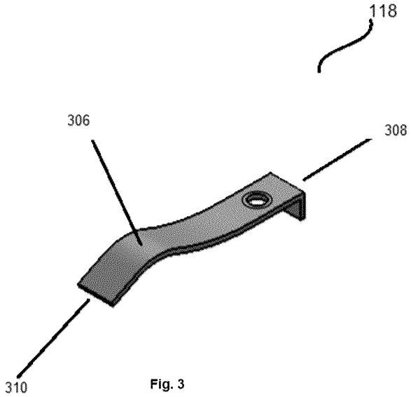

FIG. 3 is a close-up, perspective view of one leaf spring 118, whose shape allows a pair to latch onto insert 130 (not shown), held in place at grip end 306, and then flex to release the insert 130 when linear, upward force is applied to insert end 310.

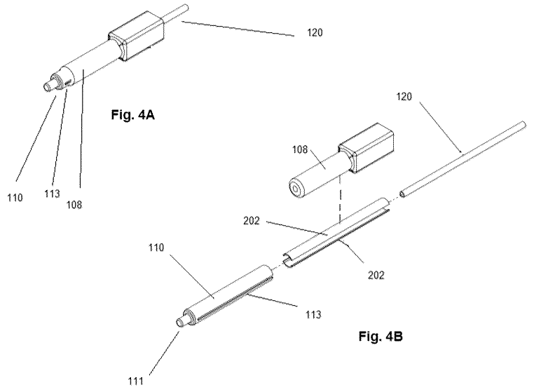

FIG. 4A is a perspective view of potting 108, with tip 110, slot 113, and air tube 120 as assembled.

FIG. 4B is an exploded perspective view of potting 108, showing more of tip 110, placement of deep leads 202, and placement of air tube 120. Electrical wires (not shown) carry electrical current to deep leads 202. Deep leads 202 are connected inside tip 110. Tip 110 forms an electrical short circuit, which produces heat at the tip 110, and in particular near alignment protrusion 111. Air tube 120 passes between the deep leads 202 pair and into the tip 110 without contact. One purpose of the air tube 120 is to provide ventilation at the tip 110, in cooperation with exposed slots 113. The assembled combination of air tube 120, tip 110, and deep leads 202 resides inside potting 108, and moves together linearly, upward or downward as the air tube 120 is directed.

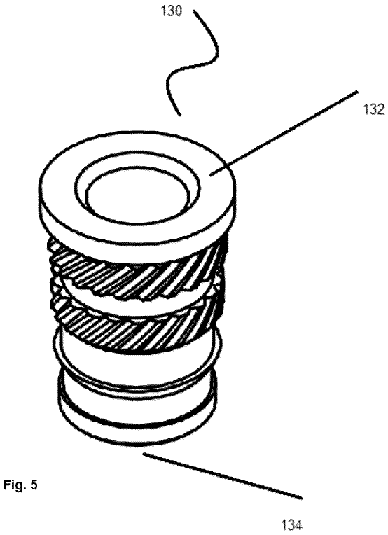

FIG. 5 is a close-up view of insert 130. Typically made of brass or other metal, insert 130 is generally configured provided with knurls, grooves, undercuts, and other physical attributes to dig into and become affixed to heated, softened plastic. Insert 130 has a top 132 and bottom 134. The bottom 134 makes initial contact with a surface into which insert 130 is pressed. Pressing force is applied at the top 132.

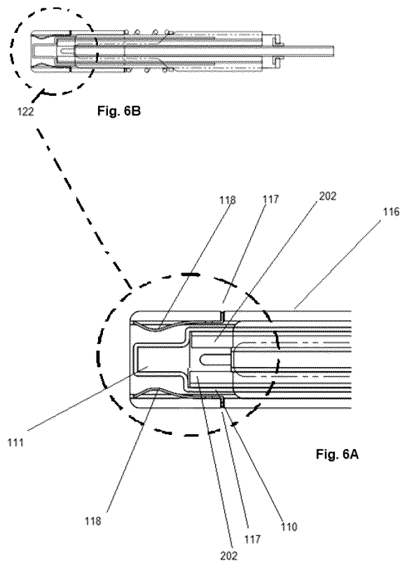

FIG. 6 is a cross-section view of operation end 122 of insert staker 100. On insert collar 116, a pair of notches 117 secures anchor end 308 of a pair of leaf springs 118, so that the leaf springs are contained inside insert collar 116. Thus, when the top 302 of insert 130 is inserted into operation end 122, leaf springs 118 will grasp it via grip surfaces 306. Alignment protrusion 111 will promote proper alignment of insert 130. When held thusly, insert 130 receives heat produced within tip 110 from a short circuit that it creates from electricity supplied via deep leads 202. Consider now a hole (not shown) in a plastic part (not shown), where the diameter of the hole is slightly smaller than the outside diameter of the insert 130 and smaller than the outside diameter of the operation end 122. When operation end 122, containing insert 130, is pressed into the hole (not shown), heat softens the plastic and allows the insert 130 to be pressed into the hole. When the plastic is cooled enough to secure insert 130, the operation end 122 is withdrawn, and insert 130 slips from and is released from the leaf springs 118 and grip surfaces 306.

In an alternative embodiment, insert 130 may be pre-placed and aligned in hole 304 by other means, thusly requiring only heat and directed force to press insert 130 into plastic part 302. Insert collar 116, leaf springs 118, and bracket 102 would no longer be required. Potting 108 may be required be needed to cooperate with spring 114 in the movement of the combination of insert collar 116 and bracket 102. Potting 108 would be needed to house and contain tip 110, deep leads 202, and electrical wires. Potting 108 would still be connected to air tube 120, for transferring force from air tube 120 to potting 108. Tip 110 would provide heat to insert 130 as well as transfer force from potting 108 to insert 130.

FIG. 7 shows yet another alternative embodiment wherein insert 130 is already placed, and insert staker 400 positions itself and finishes staking. This limited side view of insert staker 400 shows an air tube 402, which passes through carriage 406. Carriage 406 slides linearly across rail 410, on bearings 407. Rail 410 is secured to base 412, and base 412 is secured to mount 414. As with previous embodiments, this alternative includes potting 408, tip 110, and alignment protrusion 111. This embodiment, as would others, includes hole 415 which allows air from the air tube to be release into insert 130 (not shown here) to enhance cooling of insert 100. Force is directed along air tube 402, transferred to potting 408, and then transferred through tip 110 and onto insert 130. As an assembled combination, air tube 402, carriage 406, and bearings 407 move as one along the rail 410. A spring, not shown, dampens the movement of the assembled combination of air tube 40, carriage 406, and bearings 407 along the rail 410.

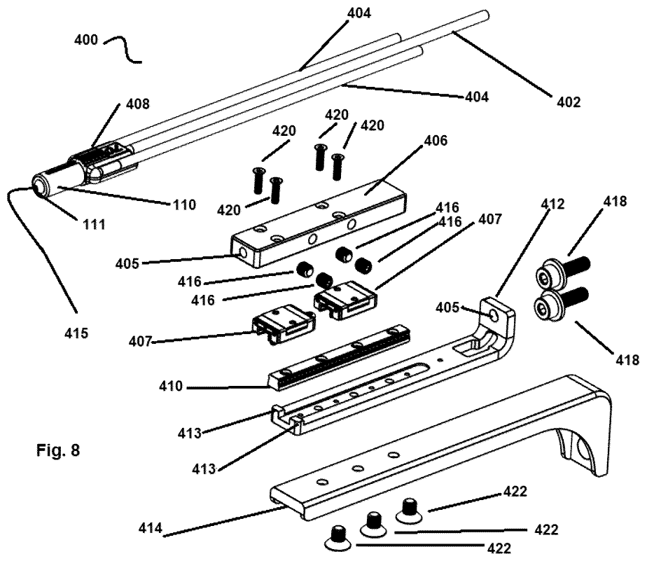

FIG. 8 is an exploded perspective view of insert staker 400, further revealing components and structure. In addition to components previously stated n FIG. 7, FIG. 8 reveals screws 422 that secure base 412 to mount 414. Rail 410 is secured changeably to base 412, so that the position of rail 410 may be set along base 412. Base 412 includes stops 413 which are used to stop movement of carriage 406 and bearings 407 along the rail 410. Carriage 406 and bearings 407 slide along rail 410. Where carriage 406 and bearings 407 stop depends on placement of rail 410 along base 412. Screws 418 secure mount 414 to a platform (not shown) that moves the insert staker 400 linearly up and down as needed to accomplish staking.

Still referring to FIG. 8, carriage 406 is secured to bearings 407 via screws 420, thus creating an assembly that moves along rail 410. Also, air tube 402 is positioned through the carriage 406, through holes 405 and opposite ends. FIG. 8 shows only one of holes 405. Now, air tube 402 is movable, but secured during operation to the carriage 406 via set screws 416. As with previously disclosed embodiments, linear force is directed along air tube 402 which now moves in the assembled combination including carriage 406 and bearings 407, transferred to potting 408, and then transferred through tip 110 and onto insert 130 (not shown).

Still referring to FIG. 8, tip 110 may be provided with a hole 415, through protrusion 111, to allow air forced through air tube 402 to be released into insert 130 (not shown) for cooling purposes.

Also shown in FIG. 8, for reference, are leads 404 which carry electricity to tip 110, for heating the inserts during placement. Leads 404 are secured to and assembled combination of air tube 408, carriage 406, bearings 407, potting 408, and tip 110.

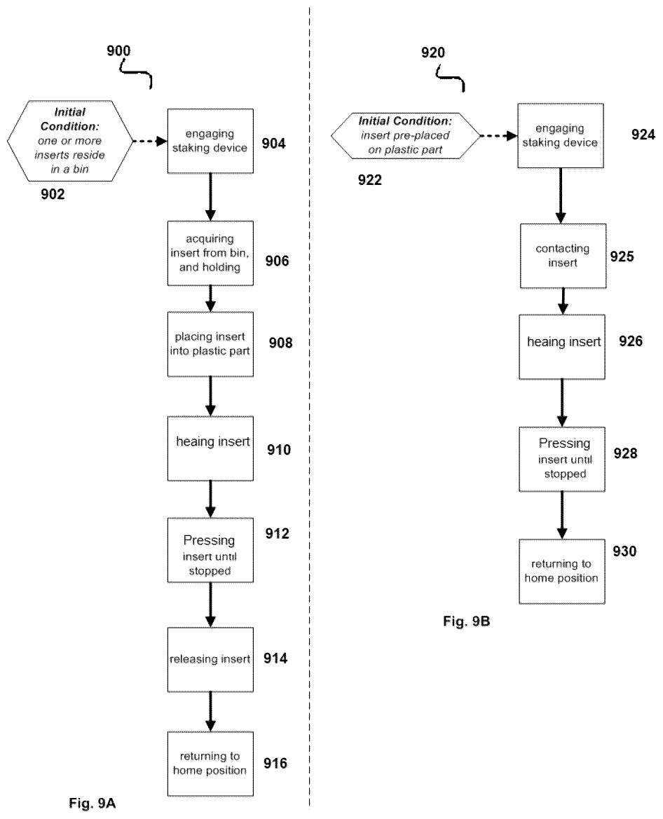

FIG. 9A discloses a method, computer or processor controlled, for insert staking where insert 130 is selected by insert staker 100, and placed. In this description, we use references elements discussed above in association with other figures. Initial conditions 902 include the insert staker 100 being in a home position. The steps include:

Engaging 904 staking device 100;

Acquiring 906 an insert 130; an insert 130 is selected from a bin or other container, and grabbed by insert staker 100.

Placing 908 the insert 130 in position into plastic part 302; insert staker 100 moves to align the insert 130 with hole 304 in the plastic part 302.

Heating 910 the insert 130; the insert 130 is heated to appropriate temperature to enable placement in the plastic part 302.

Pressing 912 the insert 130; the heated insert 130 is pressed into the plastic part 302.

Releasing 914 the insert 130; insert staker 100 releases the insert 130.

Returning 916 to home position; Insert staker 100 returns to its home position, ready to place another insert 130.

FIG. 9B discloses a method, computer or processor controlled, for insert staking where insert 130 is already placed, but not fully inserted. In this description, we use references elements discussed above in association with other figures. Initial conditions 922 include the insert staker 400 being in a home position. The steps include:

Engaging 924 staking device 100;

Contacting 925 the insert 130; Insert 130 is already in place in hole 304 in plastic part 302. Insert staker 400 must make physical contact with it in order to complete the insert staking process. Insert staker 400 moves to align with and make contact with the insert 130.

Heating 926 the insert 130; the insert 130 is heated to appropriate temperature to enable placement in the plastic part 302.

Pressing 928 the insert 130; the heated insert 130 is pressed into the plastic part 302.

Returning 930 to home position; Insert staker 100 returns to its home position, ready to perform another insert operation.

FIGS. 10A, 10B, and 10C show insert staker 100 operating in sequence to place and then release insert 130 to hole 304, in plastic part 302. Consider now hole 304 in plastic part 302, where the diameter of hole 304 is slightly smaller than the outside diameter of the insert 130 and smaller than the outside diameter of the operation end 122. The outside diameter of insert 130's bottom 134 is typically smaller than the inside diameter of hole 304. This provides a lead-in and allows insert 130 to self-locate as it is staked. FIG. 7A shows insert 130 in the grasp of insert staker 100. Now consider FIG. 7B. When operation end 122, containing insert 130, is lined up with hole 304, and then pressed against plastic part 320, the combination of insert 130, insert collar 116 and bracket 102 resist and slide in the opposite direction along the air tube 120. Spring 114 compresses to manage the resistance. Heat conducted through the tip 110, alignment protrusion 111 (not shown), and insert 130 softens the plastic and allows insert 130 to be pressed into hole 304. When the surrounding plastic is cooled enough to secure insert 130 in the plastic part 302, the operation end 122 is withdrawn, and insert 130 slips from and is released from the leaf springs 118 and grip surfaces 306.

Impulse technology is used to deliver current to the deep leads 202. The shape and placement of deep leads 202 inside tip 100 (which creates an electrical short circuit) facilitate efficient heat transfer to tip 110 near the alignment protrusion 111. The heat is transferred to insert 130, and then to the plastic part 302 and hole 304.

FIGS. 11A, 11B, 11C, and 11D show insert staker 400 operating in sequence to press insert 130 to hole 304 (not shown), in plastic part 302. In these view, FIGS. 11A, 11B, and 11D show the mount 414, which is secured to a movable platform.

FIG. 11A shows insert staker 400 in home position, with insert 130 pre-placed in plastic part 302. Tip 110 and protrusion 111 are positioned to make contact with insert 130. FIG. 11B shows potting 408 and tip 110 making contact with insert 130. FIG. 11C is a close-up view, showing that a distance 312 is maintained to limit the penetration of insert 130 into plastic part 302. This distance is determined by placement of air tube 402 within carriage 406 as established vis set screws 416, and stop 413 in base 412.

While the apparatus, system, and method have been described with reference to various embodiments, those skilled in the art will understand that various changes may be made and equivalents may be substituted for elements thereof without departing from the scope and essence of the disclosure. In addition, many modifications may be made to adapt a particular situation or material in accordance with the teachings of the disclosure without departing from the essential scope thereof. Therefore, it is intended that the disclosure not be limited to the particular embodiments disclosed, but that the disclosure will include all embodiments falling within the scope of the appended claims. In this application, all units are in the metric system and all amounts and percentages are by weight, unless otherwise expressly indicated. Also, all citations referred to herein are expressly incorporated herein by reference.

I claim:

1. An insert staking device for inserting an insert into an appropriately sized hole in a plastic part using electrically produce heat, comprising
an air tube, the air tube receiving a linear pressing force;
a tip, the tip further having an alignment protrusion;
two leads,
wherein the two leads cooperate to conduct electrical current to the tip, wherein the electrical current produces the heat in the tip,
wherein the tip conducts the heat to the insert;
potting;
wherein the potting is affixed to the air tube,
wherein the potting receives the linear pressing force from the air tube and transfers the linear pressing force to the insert,
wherein the potting encases the air tube, the tip, and the two leads;
and
the insert staking device sufficiently configured to conduct the heat from the insert to the hole in the plastic part, softening the plastic part, pressing the insert into the plastic part, disengaging from the insert, and then withdrawing from the insert.

2. The insert staking device of claim 1, further comprising
an insert collar for releasably holding the insert,
a bracket,
wherein the bracket and the insert collar are affixed and cooperate to allow movement of the bracket and insert collar along the air tube and the potting;
a spring;
wherein the potting is configured to cooperate with the spring to resist movement of the bracket and the collar along the air tube and the potting;
and
the insert staking device configured to conduct heat from the insert to the hole in the plastic part, softening the plastic part, pressing the insert into the plastic part, releasing the insert, disengaging from the insert, and then withdrawing from the insert.

3. A method for insert staking or placing an insert into an appropriately sized hole in a plastic part using impulse technology through electrical wires, comprising
beginning from initial conditions wherein the staking devices is in a home position;
engaging an insert staking device;
acquiring the insert with the impulse insert staking device;
placing the insert into a prepared hole in the plastic part;
heating the insert,
pressing the insert into the hole;
releasing the insert; and
returning the insert staking device to the home position.

4. A method for insert staking or placing an insert into an appropriately sized hole in a plastic part using impulse technology through electrical wires, comprising
beginning from initial conditions wherein the staking devices is in a home position, and wherein
the insert is pre-placed placed into a prepared hole in the plastic part;
engaging an insert staking device;
contacting the insert;
heating the insert;
pressing the insert into the hole; and
returning the insert staking device to the home position.
